(19) United States
(12) Patent Application Publication
(10) Pub. No.: US 2010/0039401 A1
(43) Pub. Date: Feb. 18, 2010

(54) ELECTRONIC DEVICE AND METHOD FOR VIEWING DISPLAYABLE MEDIAS

(75) Inventors: Xiao-Guang Li, Shenzhen City (CN); Ming-Feng Tsai, Tu-Cheng (TW); Kuan-Hong Hsieh, Tu-Cheng (TW); Han-Che Wang, Tu-Cheng (TW); Cheng-Hao Chou, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HON FUN JIN PRECISION INDUSTRY (ShenZhen)CO., LTD., Shenzhen city (CN); HON HAI PRECISION INDUSTRY CO., LTD., Tu-Cheng (TW)

(21) Appl. No.: 12/421,628

(22) Filed: Apr. 9, 2009

(30) Foreign Application Priority Data
Aug. 15, 2008 (CN) 200810303852.2

(51) Int. Cl. G06F 3/041

(52) U.S. Cl. 345/173

(57) ABSTRACT

A media viewing method is provided. The method includes: receiving touch signals; determining whether touch position that corresponds to the touch signals is at the first touch input area or the second touch input area; controlling a display unit to display a previous media or a next media if the touch position is at the first touch input area; and controlling the display unit to display a picture of a previous album or a next album if the touch posit is at the second touch input area.

### RELATED APPLICATIONS

This application is related to a co-pending U.S. patent application filed concurrently herewith whose Attorney Docket No is US 20394 and entitled “ELECTRONIC DEVICE AND METHOD FOR VIEWING DISPLAYABLE MEDIAS,” which is incorporated herein in its entirety by reference.

### BACKGROUND

1. Technical Field

The disclosure relates to electronic devices and, particularly, to an electronic device capable of viewing displayable medias and a method thereof.

2. Description of Related Art

Nowadays, many electronic devices, e.g., mobile phones, digital photo frames, electronic readers (e-reader), are capable of storing and displaying electronic documents (e.g., digital pictures, digital texts, etc). Usually, electronic documents are stored in a file. For example, a file can be an album including a plurality of digital pictures. When viewing pictures in an album, if a user wants to view another album, the user must finish paging through the remaining pictures in the present album first, or return to the operation menu and enter the commands to select and open another album, which is inconvenient and time consuming.

Therefore, it is necessary to provide an electronic device and a method to overcome the above-identified deficiencies.

### BRIEF DESCRIPTION OF THE DRAWINGS

The components in the drawings are not necessarily drawn to scale, the emphasis instead being placed upon clearly illustrating the principles of the electronic device. Moreover, in the drawings, like reference numerals designate corresponding parts throughout the several views.

FIG. 1 is a block diagram of an electronic device in accordance with an exemplary embodiment.

FIG. 2 is a flowchart illustrating a method for viewing pictures applied in the electronic device of FIG. 1, in accordance with an exemplary embodiment.

### DETAILED DESCRIPTION

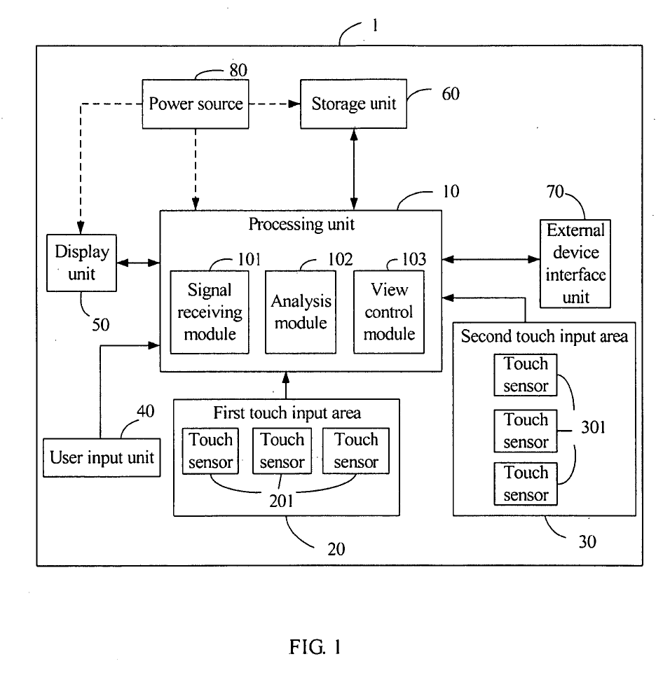

Referring to FIG. 1, an electronic device 1 includes a processing unit 10, a first touch input area 20, a second touch input area 30, a user input unit 40, a display unit 50, a storage unit 60, an external device interface unit 70 such as an input port or wireless transceiver, and a power source 80.

The interface unit 70 is configured to connect to an external electronic device (not shown). The external device can be a storage card (for example, a secure digital (SD) card, a compact flash (CF) card) or another electronic device (for example, a digital camera, a mobile phone, or a computer).

The user input unit 40 is configured to generate instructions in response to user operations. The user input unit 40 can be an input key (e.g., button), a knob, and the like. The power source 80 is configured to provide power to elements of the electronic device 1, such as the processing unit 10 and the display unit 50.

The storage unit 60 is configured to store displayable media such as digital pictures. The display unit 50 is configured to display the media. In the embodiments, digital pictures (hereinafter pictures) are used as an example to illustrate the present device and method. Further, a file containing a plurality of pictures is referred to as an album.

The first touch input area 20 and the second touch input area 30 are configured to produce touch signals in response to user operations. For example, the user can touch the first touch input area 20 and the second touch input area 30 with a finger or a stylus. In the exemplary embodiment, the first touch input area 20 is a touch sensor array that includes a plurality of touch sensors 201, and the second touch input area 30 is another touch sensor array that includes a plurality of touch sensors 301. In the exemplary embodiment, the touch sensors 201 are arranged one by one in a row and the touch sensors 301 are arranged one by one in a column. Each of the touch sensors 201 and 301 are assigned identification codes. In the exemplary embodiment, the identification codes are coordinates according to an X-Y coordinate system. The touch sensors 201 of the first touch input area 20 are assigned a first group of coordinates and the touch sensors 301 of the second touch input area 30 are assigned a second group of coordinates.

The processing unit 10 includes a signal receiving module 101, an analysis module 102, and a view control module 103.

The signal receiving module 101 is configured for receiving touch signals produced by the first touch input area 20 and the second touch input area 30. The analysis module 102 is configured to determine a touch position according to the touch signals received by the signal receiving module 101. Because each of the touch sensors 201 and 301 are assigned coordinates, the touch signal produced by the touch sensor 201 or 301 associated with the coordinates indicates the touch position. In detail, the analysis module 102 analyzes coordinates associated with the touch signals, and determines the touch position is at the first touch input area 20 if the coordinates is in the first group of coordinates, and determines the touch position is at the second touch input area 30 if the coordinates is in the second group of coordinates.

The view control module 103 is configured for controlling which picture from which album is displayed on the display unit 50 according to the analysis result from the analysis module 102. If the touch position is at the first touch input area 20, the view control module 103 controls the display unit 50 to display a previous picture or a next picture, and if the touch position is at the second touch input area 30, the view control module 103 controls the display unit 50 to display a picture of a previous album or a next album.

The analysis module 102 is also configured for determining the path of a sliding touch (hereinafter touch path). When a plurality of touch sensors 201 or 301 are touched by the user, the signal receiving module 101 receives a plurality of touch signals in response to the user's operation, and the analysis module 102 analyzes the change of the coordinates of the touch signals to determine the touch path. For example, if the touch position is at the first touch input area 20 and the coordinates of the touch signals gradually increased along the X axes, the analysis module 102 determines that the touch path is from left to right; if the touch position is at the first touch input area and the coordinates of the touch signals are gradually decreased along the X axes, the analysis module 102 determines that the touch path is from right to left. If the touch position is at the second touch input area 30, and the coordinates of the touch signals are gradually increased along the Y axes, the analysis module 102 determines that the touch path is from down to up, if the touch position is at the second touch input area 30 and the coordinates of the touch signals are gradually decreased along the Y axes, the analysis module 102 determines that the touch path is from up to down.

In addition, the view control module 103 further controls to view the pictures according to the touch path. In detail, if the analysis module 102 determines the touch position is at the first touch input area 20 and the touch path is from left to right, the view control module 103 controls the display unit 50 to display the previous picture; and if the analysis module 102 determines the touch point is at the first touch input area 20 and the touch path is from right to left, the view control module 103 controls the display unit 50 to display the next picture. If the analysis module 102 determines the touch position is at the second touch input area 30 and the touch path is from up to down, the view control module 103 controls the display unit 50 to display the previous album; and if the analysis module 102 determines the touch point is at the second touch input area 30 and the touch path is from down to up, the view control module 102 controls the display unit 50 to display the next album. In the exemplary embodiment, the view control module 102 controls the display unit 50 to display a first picture of the previous album or the next album if the touch position is at the second touch input area 30.

In another exemplary embodiment, the view control module 102 controls the display unit 50 to display a picture of the previous album or the next album if the touch position is at the first touch input area 20, and controls the display unit 50 to display the previous picture or the next picture if the touch position is at the second touch input area 30. In other embodiments, the view control module 102 may control the display unit 50 to display a random picture of the previous album or the next album if the touch position is at the second touch input area 30.

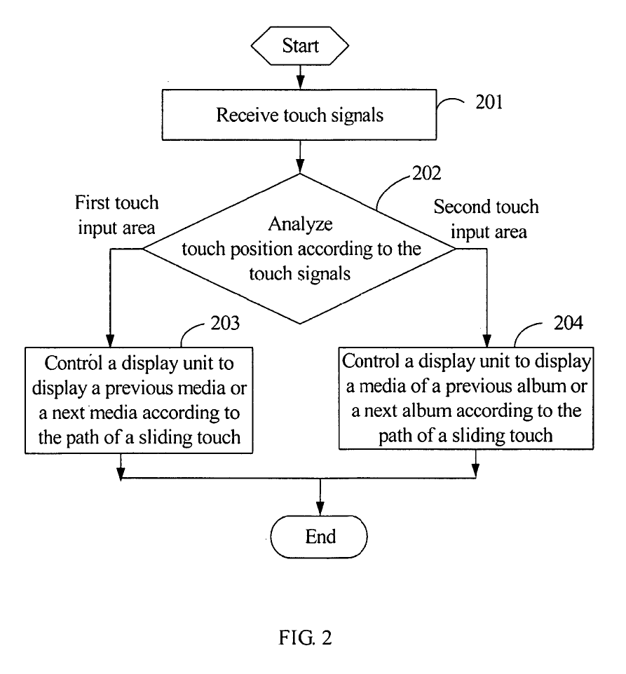

FIG. 2 is a flowchart illustrating a method for viewing pictures applied in the electronic device 1 in an exemplary embodiment. In step S201, the signal receiving module 101 receives the touch signals generated by the first touch input area 20 or the second touch input area 30 in response to user operations.

In step S202, the analysis module 102 determines whether the touch position is at the first touch input area 20 or the second input area 30 according to the touch signals. In detail, if coordinates of the touch signals are in a first group of coordinates, the analysis module 102 determines the touch position is at the first touch input area 20, and if the coordinates of the touch signals are in a second group of coordinates, the analysis module 102 determines the touch position is at the second touch input area 30.

If the touch position is at the first touch input area 20, in step S203, the view control module 103 controls the display unit 50 to display a previous picture or a next picture according to the touch path determined by the analysis module 102. The analysis module 102 further determines the touch path according to the touch signals. For example, if the coordinates reflected by the touch signals are gradually increased along the X axes, the analysis module 102 determines that the touch path is from left to right and the view control module 103 controls the display unit 50 to display the previous picture, and if the coordinates reflected by the touch signals are gradually decreased along the X axes, the analysis module 102 determines that the touch path is from right to left and the view control module 103 controls the display unit 50 to display the next picture.

If the touch position is at the second touch input area 30, in step S204, the view control module 103 controls the display unit 50 to display a picture of a previous album or a next album according to the touch path determined by the analysis module 102. The analysis module 102 also determines the touch path according to the touch signals. For example, if the coordinates reflected by the touch signals are gradually increased along the Y axes, the analysis module 102 determines that the touch path is from down to up and the view control module 103 controls the display unit 50 to display a picture of the next album. If the coordinates reflected by the touch signals are gradually decreased along the Y axes, the analysis module 102 determines that the touch path is from up to down and the view control module 103 controls the display unit 50 to display a first picture of the previous album.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. An electronic device comprising:
a processing unit;
a storage unit storing displayable medias contained in two or more albums;
a display unit configured for displaying the media;
a first touch input area and a second touch input, configured for producing touch signals in response to user operations;
wherein the processing unit further comprises:
a signal receiving module configured for receiving the touch signals produced by the first touch input area or the second touch input area;
an analysis module configured for analyzing a touch position and a path of a sliding touch according to the touch signals; and
a view control module configured for controlling the display unit to display a next media or a previous media according to the path of the sliding touch if the touch position is at the first touch input area, and controlling the display unit to display a media of a next album or a previous album according to the path of the sliding touch if the touch position is at the second touch input area.

2. The electronic device of claim 1, wherein if the touch position is at the first touch input area, the view control module controls the display unit to display the next media if the path of the sliding touch is from right to left, and to display the previous media if the path of the sliding touch is from left to right; if the touch position is at the second touch input area, the view control module controls the display unit to display a media of the next album if the path of the sliding touch is from down to up, and to display a media of the previous album if the path of the sliding touch is from up to down.

3. The electronic device of claim 1, wherein the first touch input area comprises a plurality of touch sensors which are arranged in a row, and the second touch input area comprises a plurality of touch sensors which are arranged in a column, each of the touch sensors of the first touch input area and the second touch input area is assigned with a coordinate in an X-Y coordinate system for identification.

4. The electronic device of claim 3, wherein the first touch input area is assigned with a first group of coordinates and the second touch input area is assigned with a second group of coordinates, the analysis module analyzes the coordinates of the touch signals to determine the touch position and the path of the sliding touch.

5. The electronic device of claim 1, wherein the view control module controls the display unit to display a first media of the previous album or the next album if the touch position is at the second touch input area.

6. The electronic device of claim 1, wherein the view control module controls the display unit to display a random media of the previous album or the next album if the touch position is at the second touch input area.

7. The electronic device of claim 1, wherein the displayable media are digital pictures which are contained in two or more albums.

8. The electronic device of claim 1, wherein the electronic device is selected from the group consisting of an e-reader, a mobile phone, and a digital photo frame.

9. A method adapted for an electronic device for viewing displayable medias, the method comprising:
receiving touch signals produced by a first touch input area or a second touch input area;
determining touch position and path of a sliding touch according to the touch signals;
controlling a display unit to display a next media or a previous media according to the path of the sliding touch if the touch position is at the first touch input area;
controlling the display unit to display a media of a next album or a previous album according to the path of the sliding touch if the touch position is at the second touch input area.

10. The method of claim 9, wherein the step of determining touch position and path of the sliding touch according to the touch signals comprises:
determining the touch position by analyzing coordinates in an X-Y coordinate system reflected by the touch signals are at a first group of coordinates assigned to the first touch input area or a second group of coordinate assigned to the second touch input area; and
determining the path of the sliding touch by analyzing the change of the coordinates.

11. The method of claim 9, wherein the step of controlling the display unit to display a next media or a previous media according to the path of the sliding touch if the touch position is at the first touch input area comprises:
controlling the display unit to display the next media if the path of the sliding touch is from right to left; and
controlling the display unit to display the previous media if the path of the sliding touch is from left to right.

12. The method of claim 9, wherein the step of controlling the display unit to display a media of a next album or a previous album according to the path of the sliding touch if the touch position is at the second touch input area comprises:
controlling the display unit to display a picture of the next album if the path of the sliding touch is from down to up; and
controlling the display unit to display a picture of the previous album if the path of the sliding touch is from up to down.

13. The method of claim 12, wherein the step of controlling the display unit to display a media of a next album or a previous album according to the path of the sliding touch if the touch position is at the second touch input area further comprises:
controlling the display unit to display a first media of the next album or the previous album.

14. The method of claim 12, wherein the step of controlling to view to a next album or a previous album according to the path of the sliding touch if the touch position is at the second touch input area further comprises:
controlling the display unit to display a random media of the next album or the previous album.
